(19) United States
(12) Patent Application Publication
(10) Pub. No.: US 2014/0173518 A1
(43) Pub. Date: Jun. 19, 2014

(54) ELECTRONIC DEVICE AND METHOD AND SYSTEM FOR DISPLAYING MENU

(71) Applicant: HON HAI PRECISION INDUSTRY CO., LTD., New Taipei (TW)

(72) Inventor: CHIH-CHUN CHANG, New Taipei (TW)

(73) Assignee: HON HAI PRECISION INDUSTRY CO., LTD., New Taipei (TW)

(21) Appl. No.: 14/101,406

(22) Filed: Dec. 10, 2013

(30) Foreign Application Priority Data
Dec. 14, 2012 (TW) 101147430

(51) Int. Cl. G06F 3/0482; G06F 3/0484

(52) U.S. Cl. CPC G06F 3/0482; G06F 3/04847
USPC 715/833

(57) ABSTRACT

A menu displaying method applied to an electronic device to control the electronic device to display menu icons. The menu icons are arranged on a first path and a second part intersecting at a selection position. The menu icons are arranged on the first path circularly slide on the first path, and the menu icons are arranged on the second path circularly slide on the second path according to a manual operation. The menu icons that are arranged on the selection position is selected in response to the manual operation.

### BACKGROUND

1. Technical Field

The present disclosure relates to electronic devices, and particularly to an electronic device and a method for displaying the menu of the electronic device.

2. Description of Related Art

Electronic devices, such as a mobile phone, a palm computer, or a television, display a menu containing icons for selecting applications of the electronic device. As additional applications are added to the electronic devices, more icons are displayed on the menu. However, the icons are typically arranged row by row, which cost a lot time to select the desire application.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of an electronic device in accordance with an embodiment.

FIG. 2 shows functional blocks of the electronic device in FIG. 1 in accordance with a first embodiment.

FIG. 3 shows a menu containing a number of menu icons displayed by the electronic device in FIG. 1.

FIG. 4 shows a menu icon being selected in FIG. 3.

FIG. 5 shows a flowchart of a menu displaying method in accordance with a first embodiment.

FIG. 6 shows a schematic view of an electronic device of FIG. 1 in accordance with a second embodiment.

FIG. 7 shows functional blocks of the electronic device of FIG. 6.

FIG. 8 shows a remote menu displayed by the electronic device of FIG. 7.

FIG. 9 shows a remote menu icon being selected in FIG. 7.

FIG. 10 shows a system menu displayed by the electronic device of FIG. 7.

FIG. 11 shows a flowchart of a menu displaying method in accordance with a second embodiment.

### DETAILED DESCRIPTION

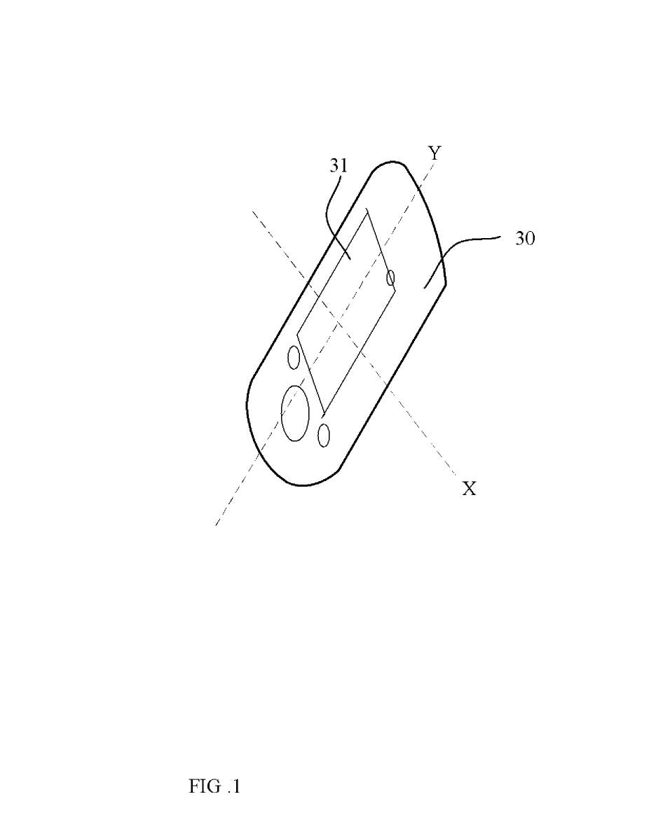

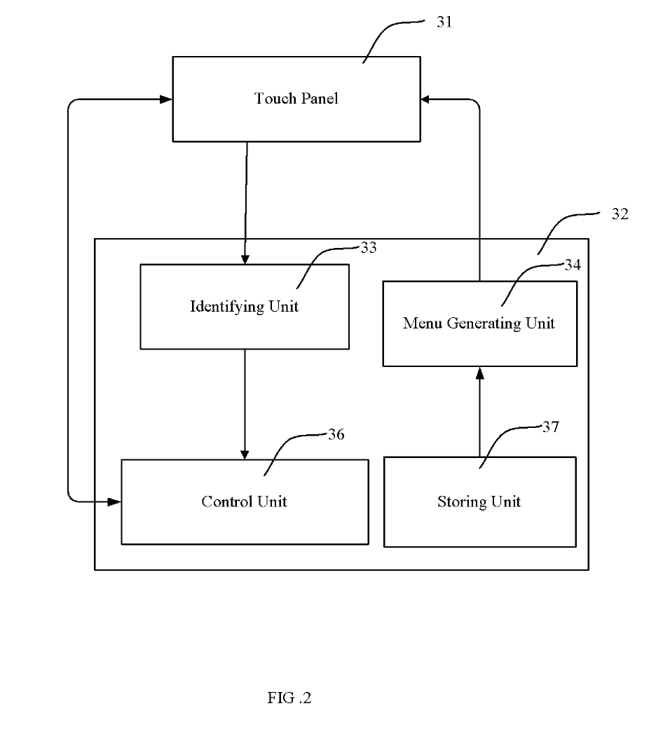

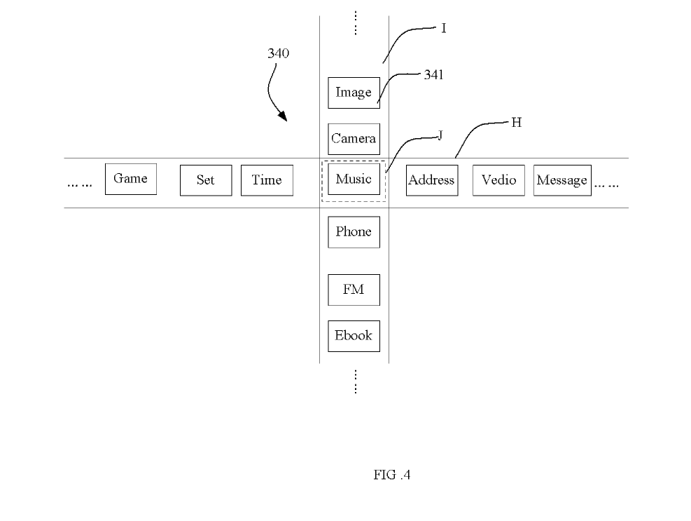

FIGS. 1-4 show an electronic device 30 in accordance with a first embodiment. The electronic device 30 may be a mobile phone, a PDA, a notebook, a panel computer, for example.

The electronic device 30 includes a touch panel 31 and a menu displaying system 32. The menu displaying system 32 includes an identifying unit 33, a storing unit 37, a menu generating unit 34, and a control unit 36. The storing unit 37 stores a number of menu items 341.

The touch panel 31 detects whether a start operation related to the touch panel 31 occurs and generates a start instruction when the start operation occurs. In this embodiment, the start operation is that a touch is maintained on a certain position of the touch panel for 5s.

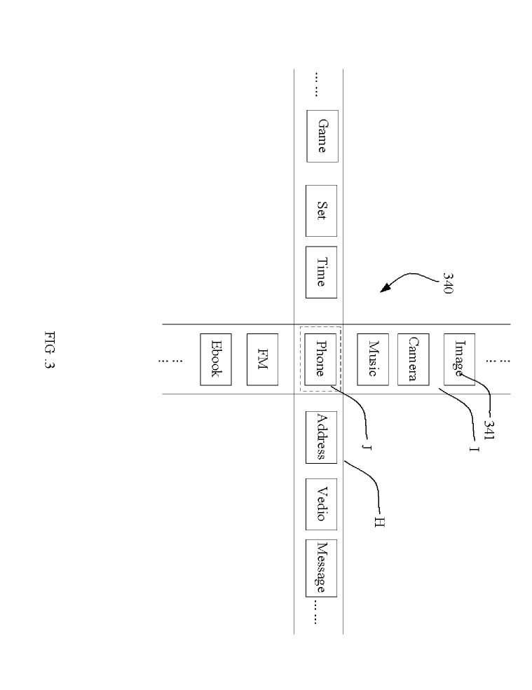

The menu generating unit 34 responds to the start operation to generate a user menu 340 containing a number of the menu items 341 and display the menu 340 on the touch panel 31. The menu icons 341 are arranged on a first path H and a second path I, the first path H and the second path I both intersect at a selection position J (see FIG. 3).

The touch panel 31 further detects whether a sliding operation occurs, and generates a detection instruction when the sliding operation occurs. The sliding operation is that a touch slides on the touch panel 31.

The identifying unit 33 responds to the detection instruction to identify an orientation and a speed about the sliding operation to generate a sliding instruction.

The control unit 36 responds to the sliding instruction to control the menu icons 341 arranged on the first path H to slide on the first path H or the menu icons 341 arranged on the second path I to slide along the second path I based on identified orientation and the identified speed. In detail, when the touch-slide on the touch panel slides along an X-axis or along a line at angle being equal to or smaller than 45 degree to the X-axis at a first speed, the orientation is the X-axis, the menu icon 341 arranged on the first path H will slide on the first path H at the first speed. When the touch on the touch panel 31 along a Y-axis or a line at angle being equal to or smaller than 45 degree to the Y-axis at a second speed, the orientation is the Y-axis, the menu icon 341 arranged the second path I will slide on the second path I at the second speed. The first path H and the second path I are beelines along the X-axis and the Y-axis intersecting with each other. In other embodiment, the first path H and the second path I are curved lines intersecting with each other.

The touch panel 31 further detects whether a selection operation related to the touch panel 31 occurs, and generates a selection instruction when the selection operation occurs. The selection operation is a click on the touch panel 31.

The control unit 36 responds to the selection instruction to control the menu icons 341 to stop sliding and select the menu icon 341 which is arranged on the selection position J when the menu icons 341 stops sliding.

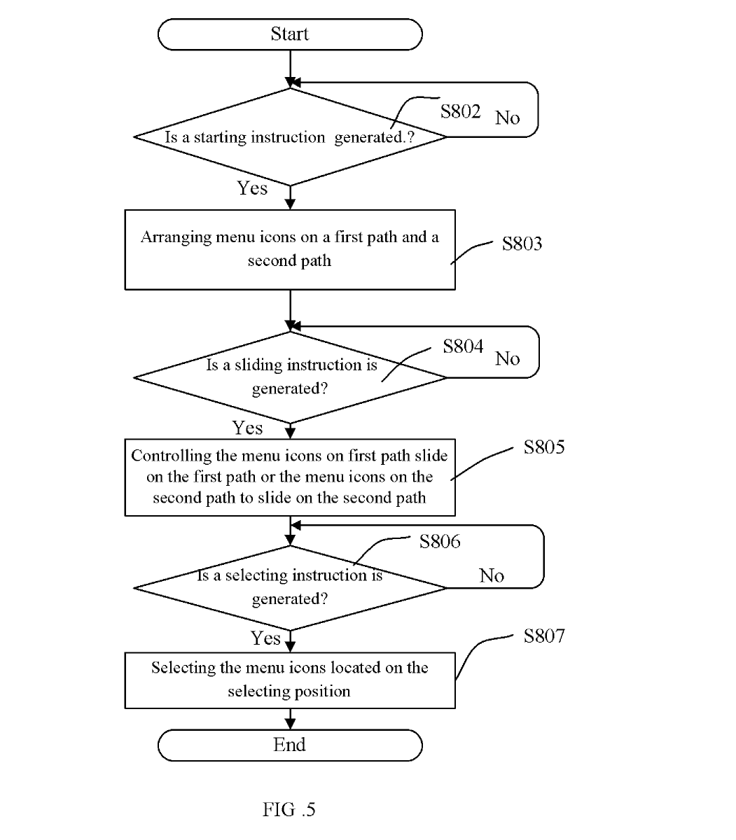

FIG. 5 shows a method for displaying a menu of an electronic device. The electronic device includes a touch panel. The method includes the following steps.

In step S802, determining whether a start instruction is generated. In this embodiment, a touch is maintained on a position on the touch panel for 5s, the start instruction is generated. When the start instruction is generated, the process goes to step S803, otherwise, step S802 is repeated.

In step S803, arranging menu icons on a first path and a second path one by one. The first path and the second path both intersect at a selection position. In this embodiment, the first path and the second path are beelines along an X-axis and a Y-axis crossing with each other. In other embodiments, the first path and the second path are curved lines intersecting with each other.

In step S804, determining whether a sliding instruction is generated. In this embodiment, when the touch slides on the X-axis or the Y-axis, the sliding instruction is generated. When the sliding instruction is generated the process goes to step S805, otherwise, step S804 is repeated.

In step S805, identifying an orientation and a speed based on the sliding instruction, and controlling the menu icons on first path slide on the first path or the menu icons on the second path to slide on the second path based on the identified orientation and the identified speed. In detail, when the touch-slide on the touch panel slides along the X-axis a first speed, the menu icon located on the first path will slide along the X-axis at the first speed. When the touch on the touch panel slide on the Y-axis at a second speed, the menu icon arranged on the second path will slide on the Y-axis at the second speed.

In step S806, determining whether a selection instruction is generated. In detail, when a click on the touch panel occurs, the selection instruction is generated. When the selection instruction is generated, the process goes to step S807, otherwise step S806 is repeated.

In step S807, the menu icons are stopped from sliding, and position of the menu icons is selected as to where the menu icons stop sliding.

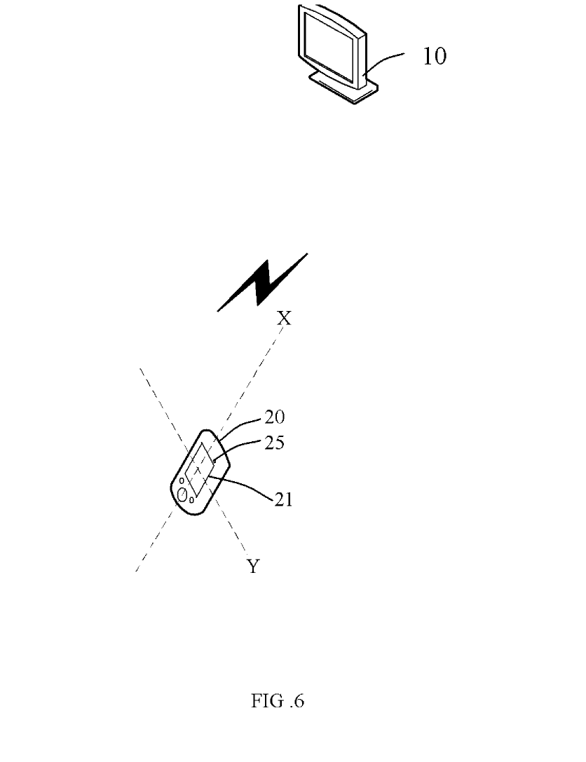

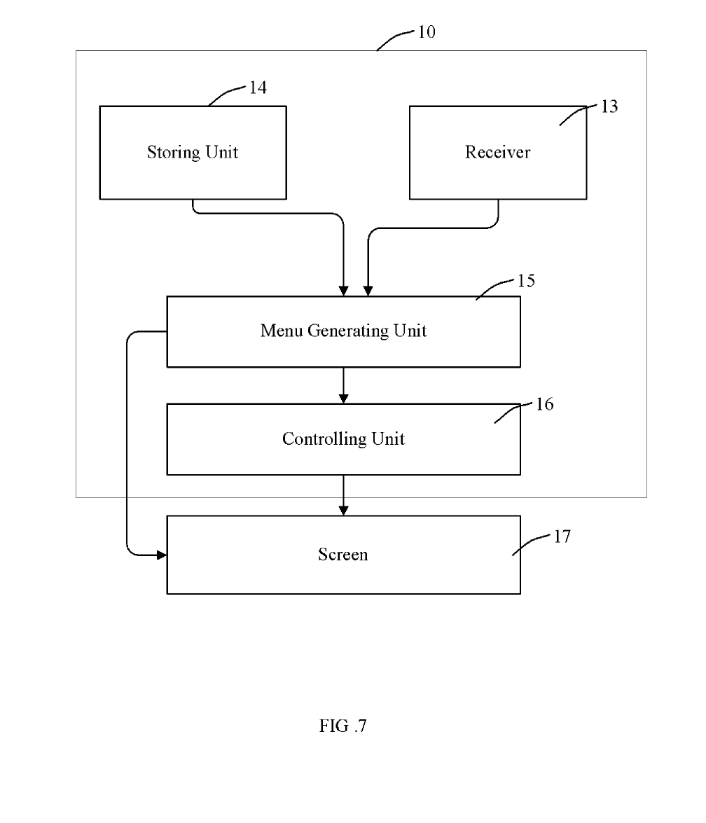

FIGS. 6-7 show an electronic device 10 in accordance with a second illustrated embodiment. The electronic device 10 is a television manipulated by a remote control 20. The remote control 20 communicates with the electronic device 10 wirelessly.

The remote control 20 includes a touch panel 21 and a transmitter 25. The touch panel 21 determines whether a start operation related to the touch panel 21 occurs, and generates a start instruction when the start operation occurs. The start operation is that a touch is maintained on a position on the touch panel 21 for 5s. In this embodiment, the touch panel 21 responds to the start instruction to turn off a backlight of the touch panel 21 to save energy.

The touch panel 21 further detects whether a sliding operation occurs, and generates a sliding instruction containing an orientation and a speed about the sliding operation. The sliding operation is that a touch slides on the touch panel 21 along an X-axis or Y axis. The orientation is X-axis or Y-axis.

The touch panel 21 further detects whether a selection operation occurs, and generates a selection instruction when the selection operation occurs. The selection operation is that a click on the touch panel 21.

The transmitting unit 25 transmits the start instruction, the sliding instruction, and the selection instruction to the electronic device 10. The transmitting unit 25 may be an infrared transmitter.

The electronic device 10 is manipulated by the start instruction, the sliding instruction and the selection instruction. In detail, the electronic device 10 includes a menu displaying system 11 and a screen 17. The menu displaying system 11 includes a receiver 13, a storage unit 14, a menu generating unit 15, and a control unit 16. All positions on the screen 17 are mapped with all positions on the touch panel 21.

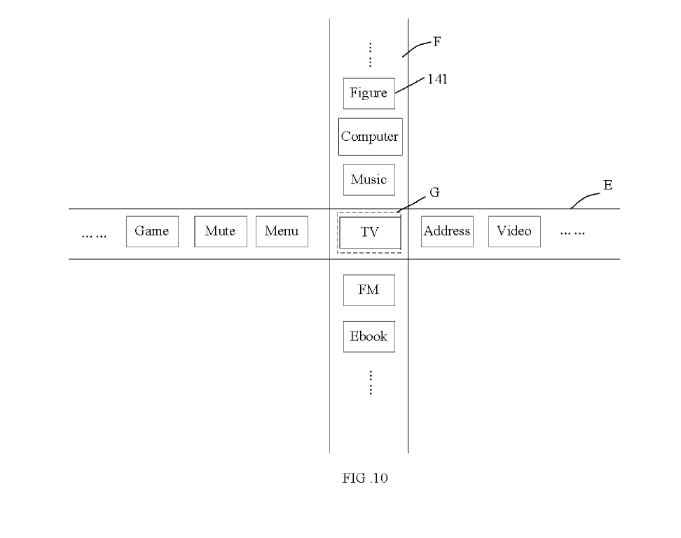

The storage unit 14 stores a number of remote control icons 140 and a number of system menu icons 141(see FIG. 10).

The receiver 13 receives the start instruction, the sliding instruction, and the selection instruction. The receiver 13 is an infrared receiver.

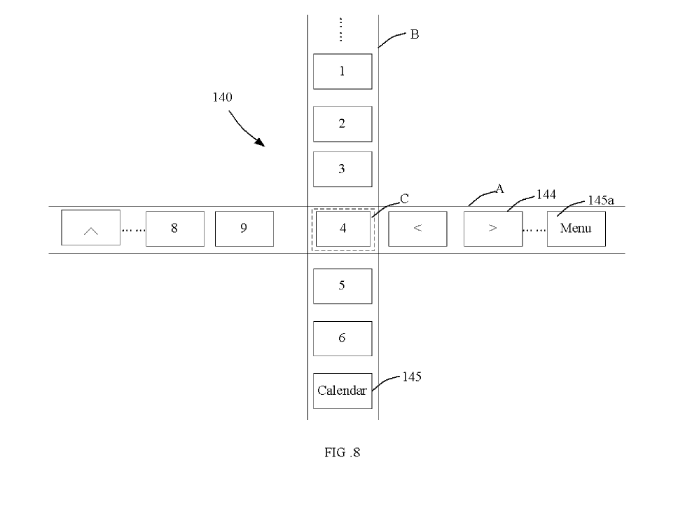

The menu generating unit 15 responds to the start instruction and displays the remote control icons 140 on the screen 17. The remote control icons 140 are arranged on a first path A and a second path B both intersecting at a first selection position C (see FIG. 8). In detail, the remote control unit icons 140 include number keys 143, orientation keys 144, and functional keys 145 for example. The first path A and the second path B are beelines crossing each other. In other embodiments, the first path A and the second path B are curved lines intersecting with each other.

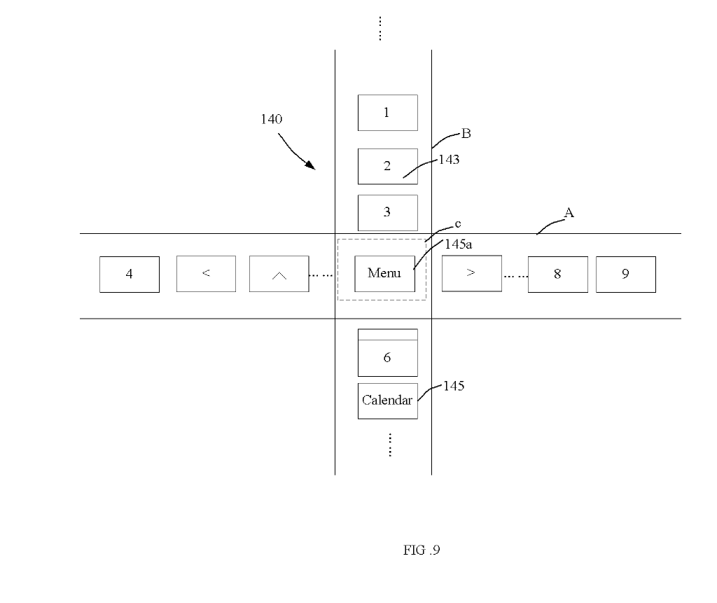

The control unit responds to the selection instruction to identify an orientation and a speed of the sliding information contained in the selection instruction, and controls the remote control icons 140 to slide based on the identified orientation and the identified speed (see FIG. 9). In detail, when the touch-slide slides along an X-axis or a line at an angle being equal to or smaller than 45 degree to the X-axis at a first speed, so that the identified orientation is the X-axis and the speed is the first speed, the control icons 140 that are arranged on the first path A will slide on the first path A at the first speed. Likewise, when the touch slides along the Y-axis or a line at an angel being equal to or smaller than 45 degree to the Y-axis at a second speed, the control icons 140 arranged on the second path B will slide on the second path B at the second speed.

The control unit 16 further responds to the selection instruction to stop the remote control icon 140 from sliding and selects the remote control icon 140 that is arranged at the first selection position C to enable the electronic device 10 to perform associated function. In FIG. 9, for example, when a system menu functional key 145a of the remote control icons 140 is located at the first selecting icon c, the system menu icon 145a is selected to generate an operating instruction.

The menu generating unit 15 further responds to the operating instruction to display a system menu 146 containing a number of system menu icons 141 on the screen 17. The system menu icons 141 are arranged on a third path E and a fourth path F, the third path E and the fourth path E both intersecting at a second selection position G (see FIG. 10). At this time, when the receiving unit 13 receives the sliding instruction, the system menu icons 141 arranged on the third path E will slide on the third path E, and the system menu icons 141 arranged on the fourth path F will slide on the fourth path F like the remote control icons 140. When the receiving unit 13 receives the selected instruction, the control unit 16 controls the system menu icons 141 to stop sliding and select the system menu icon 141 that are arranged at the second selection position G to enable the electronic device 10 to perform associated function.

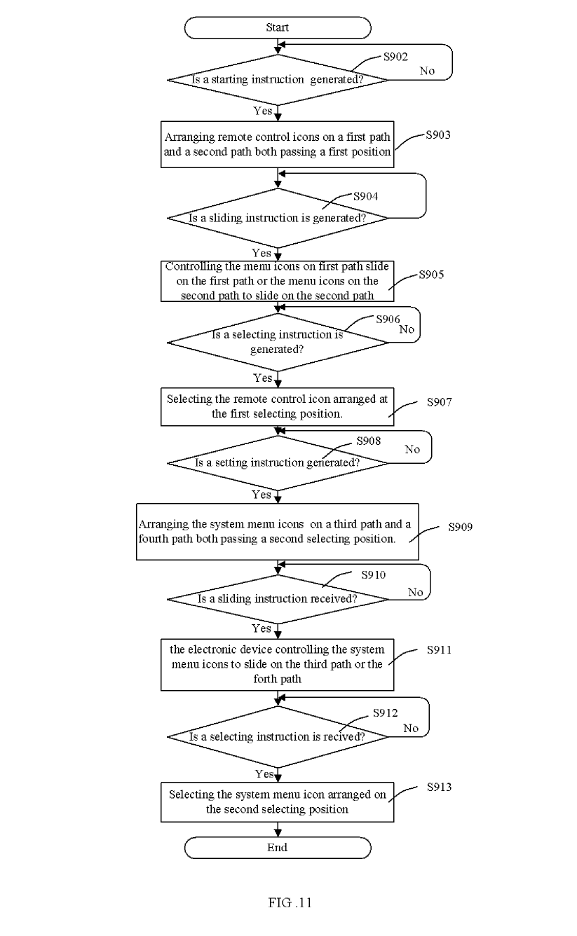

FIG. 11 shows a method for displaying a menu of an electronic device in accordance with a second embodiment. The electronic device is manipulated by a remote control. The electronic device is a television. The electronic device includes a screen. The remote control includes a touch panel. The menu displaying method includes the following steps.

In step S902, the electronic device determines if a start instruction from the remote control is received. In detail, when a touch is maintained on a position on the touch panel for 5s, the start instruction is generated and transmitted to the electronic device. When the start instruction is generated, the process goes to step S903, otherwise step S902 is repeated.

In step S903, the electronic device displays a number of remote control icons on the screen, the remote control icons being arranged along a first path and a second path, the first path and the second path both intersect at a first selection position. The first path and the second path are beeline crossing with each other.

In step S904, the electronic device determines if a sliding instruction from the remote control is received. In detail, when a touch slides on the touch panel along an X-axis or a Y-axis, the sliding instruction is generated. When the sliding instruction is received, the process goes to step S905, otherwise, step S904 is repeated.

In step S905, the electronic device controls the remote control icons arranged on the first path to slide on the first path, and the remote control icons arranged on the second path to slide on the second path in response to the sliding instruction. In detail, when the touch slide on the touch panel along the X-axis, the remote control icons arranged on the first path slide on the first path, when the touch-slide slides on the touch panel along the Y-axis, the remote control icons arranged on the second path slide on the second path.

In step S906, the electronic device determines if a selection instruction from the remote control is received. When the selection instruction is received, the process goes to step S907, otherwise step S907 is repeated.

In step S907, the electronic device selects the remote control icon arranged at the first selection position.

In step S908, the electronic device determines a setting instruction is generated. When the setting instruction is generated, the process goes to step S909, otherwise step S908 is repeated.

In step S909, the electronic device controls the remote control icons to disappear from the screen and displays a number of system menu icons on the screen, the system menu icons are arranged on a third path and a fourth path, the third path and the fourth path both intersecting at a second selection position.

In step S910, the electronic device determines if the sliding instruction from the remote control is received. When the sliding instruction is received the process goes to step S911, otherwise step S901 is repeated.

In step S911, the electronic device controls the system menu icons to slide on the third path or the forth path. In this illustrated embodiment, when the touch-slide slides on the touch panel along the X-axis, the system menu icons that are arranged on the first path slide on the third path circularly; when the touch-slide slides on the touch panel along the Y-axis, the system menu icons that are arranged on the fourth path slide circularly on the fourth path.

In step S912, the electronic device determines whether the selected instruction from the remote control is received. When the selected instruction is received the process goes to step S913, otherwise step S912 is repeated.

In step S913, the electronic device selects the system menu icon arranged on the second selected position.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a touch panel generating a start instruction according to a start operation related to the touch panel and a sliding instruction according to a sliding operation related to the touch panel;
a menu generating unit responding to the start instruction to arrange a plurality of menu icons on a first path and a second path both intersecting at a selection position in response to the start instruction; and
a control unit responding to the sliding instruction to control the menu icons arranged on the first path to slide on the first path circularly or to control the menu icons arranged on the second path to slide on the second path circularly.

2. The electronic device of claim 1, wherein the touch panel further generates a selection instruction in response to a selection operation related to the touch panel, the control unit further responds to the selection instruction to control the menu icons to stop sliding and select the menu icons arranged on the selection position.

3. The electronic device of claim 1, wherein the sliding operation is a touch sliding operation on the touch panel, the control unit controls the menu icons to slide at a speed of the touch-slide.

4. The electronic device of claim 1, wherein the electronic device further comprises an identifying unit to identifying whether the touch-slide slides along the X-axis or the Y-axis, and when the touch-slide slides along the X-axis, the control unit controls the menu icons arranged on the first path to slide on the first path; when the touch-slide slides along the X-axis, the control unit controls the menu icons arranged on the second path to slide on the second path.

5. The electronic device of claim 1, wherein the start operation is a touch is maintained on a position on the touch panel for a predetermined time period.

6. The electronic device of claim 1, wherein the selection operation is a click on the touch panel.

7. A menu displaying method, comprising steps of:
determining whether a start instruction is received;
when the start instruction is received, displaying a plurality menu icons being arranged on a first path and a second path, the first path and the second path intersecting at a selection position;
determining whether a sliding instruction is received; and
when the sliding instruction is received, controlling the menu icons arranged on the first path to slide on the first path circularly or controlling the menu icons arranged on the second path to slide on the second path circularly.

8. The menu displaying method of claim 7, wherein the first path and the second path are beelines intersecting with each other.

9. The menu displaying method of claim 7, wherein the sliding instruction comprises an X-axis or a Y-axis, the to control the menu icons arranged on the first path to slide on the first path when the sliding instruction contained the X-axis is received, the menu icons arranged on the second path is controlled to slide on the second path when the sliding instruction contained the Y-axis is received.

10. The menu displaying method of claim 7, wherein the sliding instruction further comprising a speed, when the sliding instruction is received, the menu icons is controlled to slide at the speed.

11. A system for displaying menu, applied to a TV, the TV is control by a remote control, the menu display system comprising:
a menu generating unit responding to a start instruction from the remote control to display a menu on a screen, the menu containing a plurality of menu icons arranged on a first path and a second path intersecting with the first path in response to the start instruction; and
a control unit responding to a sliding instruction from the remote control to control the menu icons arranged on the first path to slide on the first path circularly or to control the menu icons arranged on the second path to slide on the second path circularly.

12. The system of claim 11, wherein the control unit controls the menu icons to slide at a speed contained in the sliding instruction.

13. The system of claim 11, wherein the control unit controls the menu icons arranged on the first path to slide on the first path according to an X-axis contained in the sliding instruction, and controls the menu icons arranged on the second path to slide on the second path according to a Y-axis perpendicular to the X-axis contained in the sliding instruction.

14. The system of claim 11, wherein the first path and the second path both intersecting at a selection position.

15. The system of claim 14, wherein the control unit responds to a selection instruction from the remote control to select a menu icon arranged on the selection position.
